(19) United States
(12) Patent Application Publication
(10) Pub. No.: US 2023/0109068 A1
(43) Pub. Date: Apr. 6, 2023

(54) INFORMATION PROCESSING SYSTEM AND CONTROL METHOD FOR CONTROLLING INFORMATION PROCESSING SYSTEM

(71) Applicant: CANON KABUSHIKI KAISHA, Tokyo (JP)

(72) Inventor: Mayumi Shibao, Tokyo (JP)

(21) Appl. No.: 17/937,367

(22) Filed: Sep. 30, 2022

(30) Foreign Application Priority Data
Oct. 4, 2021 (JP) 2021-163471

(51) Int. Cl. H04N 1/00; G06F 3/12; H04W 12/06

(52) U.S. Cl. CPC H04N 1/00307; G06F 3/1256; G06F 3/1208; G06F 3/1238; G06F 3/1222; G06F 3/1236; H04W 12/06; G06F 3/1292; H04W 76/10

(57) ABSTRACT

In a case where an information processing apparatus requests an image forming apparatus to authenticate wireless communication with the information processing apparatus, using set user authentication information, the image forming apparatus authenticates the wireless communication with the information processing apparatus based on the user authentication information used in the request. Then, in a case where the authentication is successful, the image forming apparatus starts the wireless communication with the information processing apparatus. Then, in a case where the wireless communication is started, the information processing apparatus transmits transmission information including the user authentication information used in the request and job setting information regarding a job that the information processing apparatus instructs the image forming apparatus to run to the image forming apparatus.

### BACKGROUND

### Field of the Disclosure

The present disclosure relates to an information processing system and a control method for controlling the information processing system.

### Description of the Related Art

In recent years, high-performance mobile terminals called a “smartphone” has been prevalent. The functions of a mobile terminal include a scan function for transmitting an instruction to perform scanning to an image forming apparatus and causing the image forming apparatus to operate, and a print function for transmitting an instruction to perform printing to the image forming apparatus and causing the image forming apparatus to operate. The functions of a mobile terminal also include a transmission function for giving an instruction to perform the operation of transmitting image data scanned by the image forming apparatus to a set destination.

In the transmission function, a user sets a transmission destination email address of image data and scan setting information (e.g., color and two-sided) on the mobile terminal, thereby forming a transmission job. If the mobile terminal transmits the transmission job to the image forming apparatus, the image forming apparatus transmits image data scanned according to the scan setting information included in the transmission job to the transmission destination email address included in the transmission job. At this time, network communication between the mobile terminal and the image forming apparatus is established, for example, according to a communication protocol such as Transmission Control Protocol/Internet Protocol (TCP/IP), near-field communication (NFC), or Bluetooth®.

The publication of Japanese Patent Application Laid-Open No. 2015-177214 discusses a technique in which a mobile terminal transmits the settings of a job made on the mobile terminal to an image forming apparatus, and when authentication is completed by an authentication operation on the image forming apparatus, the image forming apparatus runs the job.

In the method discussed in the publication of Japanese Patent Application Laid-Open No. 2015-177214, a user operates both the mobile terminal and the image forming apparatus from the setting to the execution of the job. Thus, the method has an issue in operability. On the mobile terminal, the user can operate merely some functions of the image forming apparatus. Thus, to make detailed settings of the job or recover from an error, the user performs operation on an operation panel of the image forming apparatus. In this case, the user performs an authentication operation on the image forming apparatus.

### SUMMARY

Embodiments of the present disclosure are directed to improving the operability for a user when an information processing apparatus transmits the settings of a job made on the information processing apparatus to an image forming apparatus, and when the image forming apparatus runs the job.

According to embodiments of the present disclosure, an information processing system includes an image forming apparatus and an information processing apparatus that connects to the image forming apparatus through wireless communication. The information processing apparatus includes a request unit configured to request the image forming apparatus to authenticate wireless communication with the information processing apparatus, using set user authentication information, and a transmission unit configured to, in a case where the wireless communication with the image forming apparatus is started as a result of the authentication of the wireless communication, transmit transmission information including the user authentication information used in the request and job setting information regarding a job that the information processing apparatus instructs the image forming apparatus to run to the image forming apparatus. The image forming apparatus includes a first authentication unit configured to, in a case where the image forming apparatus receives the request from the information processing apparatus, authenticate the wireless communication with the information processing apparatus based on the user authentication information used in the request, and a connection unit configured to, in a case where the authentication of the wireless communication is successful, start the wireless communication with the information processing apparatus.

Further features of the present disclosure will become apparent from the following description of exemplary embodiments with reference to the attached drawings.

### BRIEF DESCRIPTION OF THE DRAWINGS

FIG. 1 is a diagram illustrating an example of the overall configuration of a data processing system.

FIG. 2 is a diagram illustrating an example of the hardware configuration of a data processing apparatus.

FIG. 3 is a diagram illustrating an example of the hardware configuration of an image forming apparatus.

FIG. 4 is a diagram illustrating an example of the functional configuration of the data processing apparatus.

FIG. 5 is a diagram illustrating an example of the functional configuration of the image forming apparatus.

FIG. 6 is a diagram illustrating an example of an authentication screen of the image forming apparatus.

FIG. 7 is a diagram illustrating an example of a transmission setting screen of the image forming apparatus.

FIG. 8 is a diagram illustrating an example of a function selection screen of the data processing apparatus.

FIG. 9 is a diagram illustrating an example of a “transmit email to myself” screen of the data processing apparatus.

FIG. 10 is a diagram illustrating an example of a “color setting” screen of the data processing apparatus.

FIG. 11 is a flowchart illustrating an example of processing performed by the data processing apparatus.

FIG. 12A is a flowchart illustrating an example of processing performed by the image forming apparatus.

FIG. 12B is a flowchart illustrating an example of processing according to a first exemplary embodiment.

FIG. 13 is a flowchart illustrating an example of processing according to a second exemplary embodiment.

### DESCRIPTION OF THE EMBODIMENTS

Some exemplary embodiments of the present disclosure will be described below. Like numbers refer to like components in the description.

### <Overall Configuration of Data Processing System>

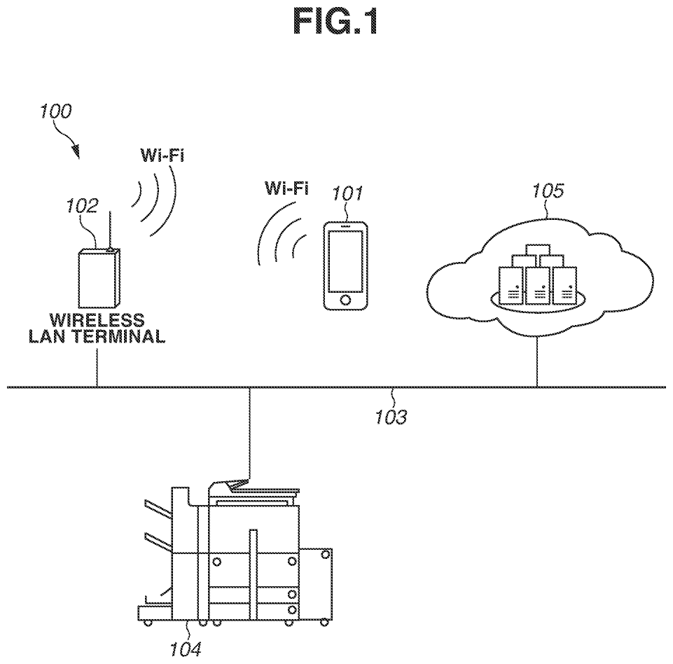

A first exemplary embodiment will be described. FIG. 1 illustrates an example of the configuration of a data processing system according to the present exemplary embodiment.

A data processing system 100 includes a data processing apparatus 101, a wireless local area network (LAN) terminal 102, an image forming apparatus 104, and a cloud server 105. These apparatuses are connected to one another via a network 103 such as a LAN. The data processing system 100 is an example of an information processing system.

The data processing apparatus 101 is a mobile terminal such as a smartphone, and may be an information processing apparatus in which an operating system (OS) for a small-sized terminal and programs for controlling a voice call, position detection, and data communication operate. Alternatively, the data processing apparatus 101 may be a personal computer (PC) that does not control a voice call and position detection. The data processing apparatus 101 can connect to the network 103 via the wireless LAN terminal 102.

The wireless LAN terminal 102 is a wireless LAN base station having a general network/router function and provides a wireless LAN through Wi-Fi in a house or an office.

The image forming apparatus 104 is a digital multifunction peripheral having various job execution functions such as a printer function, a copy function, a scanner function, and a fax transmission function. By operating the data processing apparatus 101, a user can instruct the image forming apparatus 104 to run a job and can carry out various functions of the image forming apparatus 104.

The cloud server 105 manages data used in the data processing apparatus 101 and the image forming apparatus 104 and performs extension processing of various functions via the network 103. In the present exemplary embodiment, a form is employed in which the image forming apparatus 104 and the cloud server 105 are connected to the network 103 in a wired manner. Alternatively, a form may be employed in which, similarly to the data processing apparatus 101, the image forming apparatus 104 and the cloud server 105 are wirelessly connected to the network 103 using the wireless LAN terminal 102.

Further, the data processing apparatus 101 and the image forming apparatus 104 can perform short-range wireless communication using near-field communication (NFC) or Bluetooth Low Energy (BLE). The image forming apparatus 104 transmits connection information (an Internet Protocol (IP) address or a media access control (MAC) address) for making a wireless LAN connection to the image forming apparatus 104 via NFC communication units or BLE communication units to the data processing apparatus 101 through short-range wireless communication. The data processing apparatus 101 starts wireless LAN communication with the image forming apparatus 104 using the acquired connection information.

### <Hardware Configuration of Data Processing Apparatus>

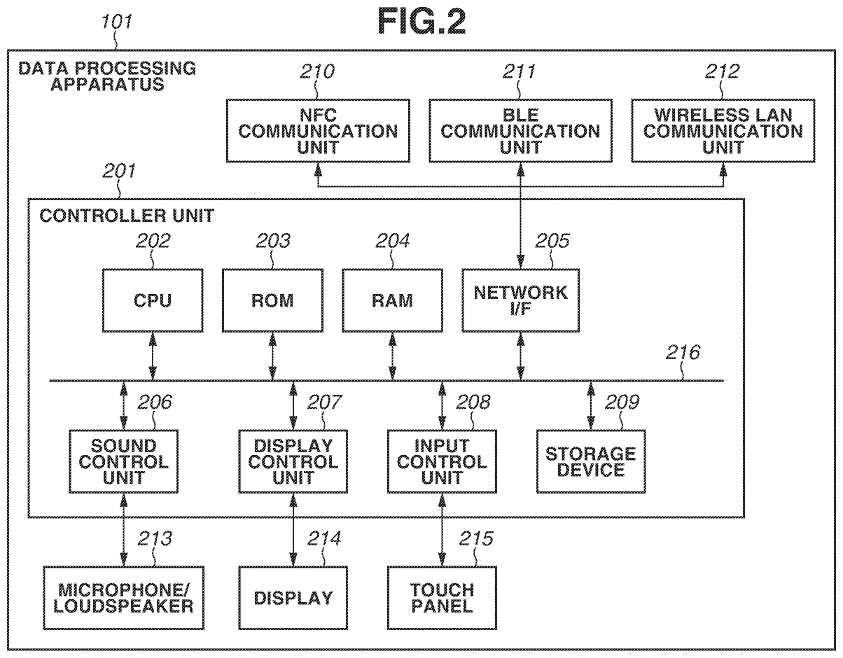

FIG. 2 illustrates an example of the hardware configuration of the data processing apparatus 101 according to the present exemplary embodiment.

The data processing apparatus 101 includes a controller unit 201. The controller unit 201 controls various communication units such as an NFC communication unit 210, a BLE communication unit 211, and a wireless LAN communication unit 212, and various user interface (UI) units such as a microphone/loudspeaker 213, a display 214, and a touch panel 215.

The controller unit 201 includes a central processing unit (CPU) 202, a read-only memory (ROM) 203, a random-access memory (RAM) 204, a network interface (I/F) 205, a sound control unit 206, a display control unit 207, an input control unit 208, and a storage device 209. These components are connected to one another via a system bus 216.

The CPU 202 controls the overall system of the data processing apparatus 101. The ROM 203 stores an OS of the data processing apparatus 101 and programs for controlling a telephone call and data communication. The processing in various flowcharts described below is carried out by the CPU 202 running programs stored in the ROM 203. The RAM 204 is used as a temporary storage area such as a main memory or a work area for the CPU 202.

The storage device 209 is a non-volatile storage device and records data on various operation mode settings to be held even after the restart of the data processing apparatus 101, and an operation log. The network I/F 205 is connected to the NFC communication unit 210, the BLE communication unit 211, and the wireless LAN communication unit 212 and exchanges information with the image forming apparatus 104 and the cloud server 105 through various types of wireless communication under control of the CPU 202.

The sound control unit 206 controls the input and output of sound data via the microphone/loudspeaker 213. The display control unit 207 controls the output of a screen to be displayed on the display 214. The input control unit 208 controls the input of information indicated through a button or the touch panel 215 by the user. The sound control unit 206, the display control unit 207, and the input control unit 208 operate under control of the CPU 202.

### <Hardware Configuration of Image Forming Apparatus>

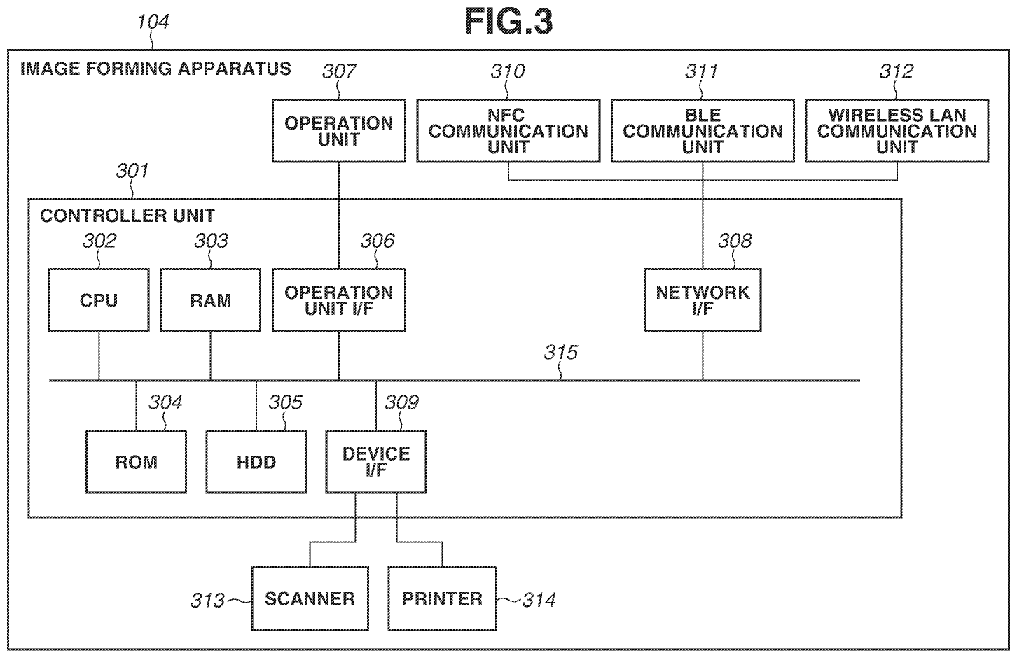

FIG. 3 illustrates an example of the hardware configuration of the image forming apparatus 104 according to the present exemplary embodiment.

The image forming apparatus 104 includes a controller unit 301. The controller unit 301 controls various communication units such as an NFC communication unit 310, a BLE communication unit 311, and a wireless LAN communication unit 312, an operation unit 307, a scanner 313, and a printer 314.

When the user uses a copy function, the controller unit 301 controls the scanner 313 to acquire image data on a document and controls the printer 314 to print the image on a sheet and output the sheet.

When the user uses a scan function, the controller unit 301 controls the scanner 313 to acquire image data on a document and convert the image data into code data, and transmits the code data to the data processing apparatus 101 or the cloud server 105 via the network 103.

When the user uses a print function, the controller unit 301 receives image data (code data) from the data processing apparatus 101 or the cloud server 105 via the network 103. Then, the controller unit 301 transmits the received image data to the printer 314. Based on the received image data, the printer 314 prints the image on a sheet and outputs the sheet.

The image forming apparatus 104 also has a fax reception function for receiving data from an Integrated Services Digital Network (ISDN) line and printing the data, and a fax transmission function for transmitting scanned data to the ISDN line.

According to an instruction to run a job set by the user, the image forming apparatus 104 performs the processing of the above various functions.

The controller unit 301 includes a CPU 302, a RAM 303, a ROM 304, a hard disk drive (HDD) 305, an operation unit I/F 306, a network I/F 308, and a device I/F 309. These components are connected to one another via a system bus 315.

The CPU 302 controls the overall system of the image forming apparatus 104. The RAM 303 is a system work memory for the operation of the CPU 302 and temporarily stores image data. The RAM 303 also stores scan image data read by the scanner 313 and stores print image data received from the data processing apparatus 101 via the network 103. The ROM 304 stores a boot program for the system and various other programs. The HDD 305 stores an OS, system software, application software, image data, and setting data. The processing in various flowcharts described below is carried out by the CPU 302 running programs stored in the ROM 304.

The operation unit I/F 306 exchanges data with the operation unit 307 under control of the CPU 302. The operation unit 307 is, for example, an operation panel having both the function of a display unit and the function of an input unit. The operation unit I/F 306 outputs information to be displayed on the operation unit 307 to the operation unit 307. The operation unit I/F 306 also receives information input by the user from the operation unit 307.

The network I/F 308 is connected to the NFC communication unit 310, the BLE communication unit 311, and the wireless LAN communication unit 312 and exchanges information with the data processing apparatus 101 and the cloud server 105 through various types of communication under control of the CPU 302.

The NFC communication unit 310 and the BLE communication unit 311 perform short-range wireless communication with the data processing apparatus 101. The wireless LAN communication unit 312 performs wireless LAN communication with the data processing apparatus 101 via the network 103. The image forming apparatus 104 receives transmission information including job setting information, image data, and a job execution command from the data processing apparatus 101 using the wireless LAN communication unit 312 and runs a job.

The device I/F 309 connects the scanner 313 and the printer 314 that read and print image data to the controller unit 301, and inputs and outputs image data under control of the CPU 202.

### <Example of Functional Configuration of Data Processing Apparatus>

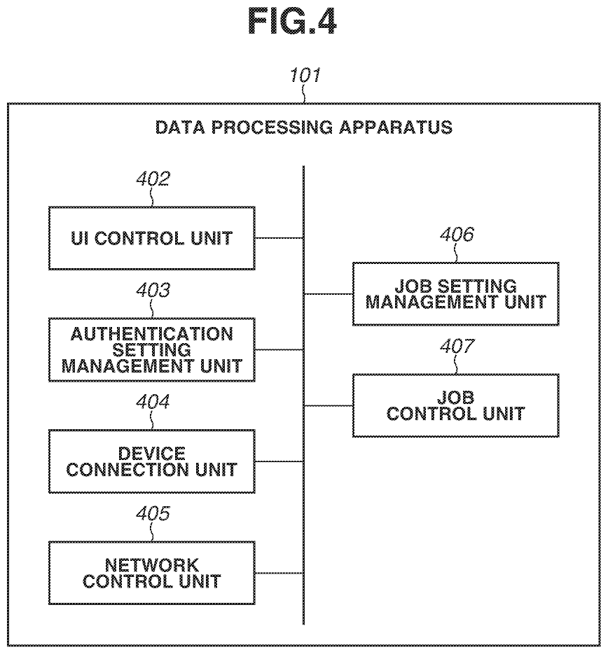

FIG. 4 illustrates an example of the functional configuration of the data processing apparatus 101 according to the present exemplary embodiment.

The controller unit 201 of the data processing apparatus 101 functions as various function units illustrated in FIG. 4 by the CPU 202 running programs stored in the ROM 203.

A UI control unit 402 receives job setting information input through the touch panel 215 by the user and provides the received content to a job setting management unit 406 via the input control unit 208. The UI control unit 402 acquires a response from the job setting management unit 406 or a job control unit 407 and outputs the acquired content to the display 214 via the display control unit 207. Further, the UI control unit 402 receives user information such as a user name and a password input through the touch panel 215 by the user and gives the user information to an authentication setting management unit 403 via the input control unit 208.

The authentication setting management unit 403 sets user information such as a user name and a password acquired from the UI control unit 402 as user authentication information and stores and manages the user authentication information in the RAM 204 or the storage device 209. The user name and the password are examples of the user authentication information. The set authentication information is used by the image forming apparatus 104 to permit the start of wireless LAN communication. Specifically, the authentication setting management unit 403 gives the authentication information to a device connection unit 404. Then, if the start of the wireless LAN communication is permitted and then the wireless LAN communication is started, the authentication setting management unit 403 gives the authentication information to a network control unit 405. The authentication information is also used by the image forming apparatus 104 to permit user operation on the operation unit 307.

The device connection unit 404 establishes short-range wireless communication using NFC or BLE via the network 103 between the data processing apparatus 101 and the image forming apparatus 104. For example, for NFC, the user brings the NFC communication unit 210 of the data processing apparatus 101 and the NFC communication unit 310 of the image forming apparatus 104 close to each other, thereby starting short-range wireless communication. For BLE, the BLE communication unit 311 of the image forming apparatus 104 transmits a beacon, and the BLE communication unit 211 of the data processing apparatus 101 receives the transmitted beacon. If it is determined that the radio wave intensity of the beacon received by the data processing apparatus 101 is a certain level or higher by the user bringing the data processing apparatus 101 close to the image forming apparatus 104, short-range wireless communication is started. As described above, the user brings the NFC or BLE communication units of the data processing apparatus 101 and the image forming apparatus 104 close to each other (a touch operation), whereby the device connection unit 404 performs short-range wireless communication with the image forming apparatus 104 and acquires connection information regarding wireless LAN communication from the image forming apparatus 104.

The device connection unit 404 connects to the image forming apparatus 104 via the network 103 using connection information acquired from the image forming apparatus 104 and makes an authentication request. The authentication request includes authentication information provided by the authentication setting management unit 403. Then, if authentication is successful, the device connection unit 404 starts wireless LAN communication with the image forming apparatus 104.

The network control unit 405 transmits a job execution command, job setting information, and image data provided by the job control unit 407 and authentication information provided by the authentication setting management unit 403 as transmission information to the image forming apparatus 104 via the network 103.

Further, the network control unit 405 receives job setting information stored in the image forming apparatus 104 via the network 103.

The job setting management unit 406 stores job setting information received by the UI control unit 402 and job setting information received from the image forming apparatus 104 or the cloud server 105 by the network control unit 405 in the RAM 204 or the storage device 209. At this time, the job setting management unit 406 may register these pieces of job setting information as “favorites” as settings frequently used by the user. The job setting management unit 406 may also register predetermined job setting information as “preset” when a program is installed.

The job control unit 407 generates a job execution command from job setting information registered as “favorites” or “preset” by the job setting management unit 406 or job setting information set by a user operation. Then, the job control unit 407 provides the generated job execution command and the job setting information to the network control unit 405. The job control unit 407 also receives the execution status of a job and the operation states of devices of the scanner 313 and the printer 314 from the image forming apparatus 104 via the network 103 and provides the execution status and the operation states to the UI control unit 402.

### <Example of Functional Configuration of Image Forming Apparatus>

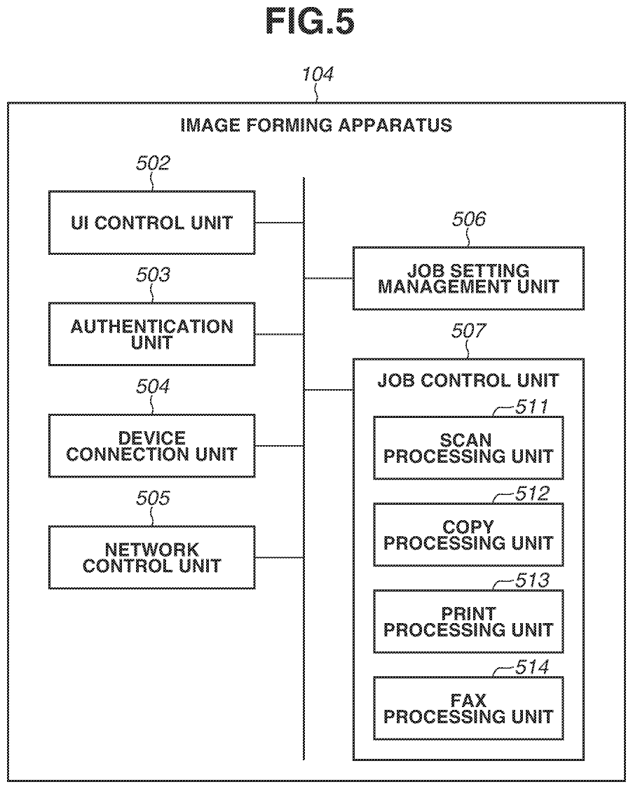

FIG. 5 illustrates an example of the functional configuration of the image forming apparatus 104 according to the present exemplary embodiment.

The controller unit 301 of the image forming apparatus 104 functions as various function units illustrated in FIG. 5 by the CPU 302 running programs stored in the ROM 304.

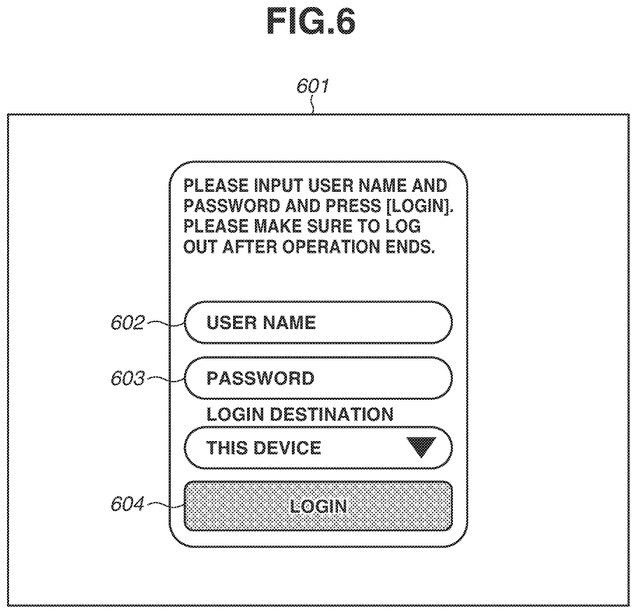

A UI control unit 502 outputs an authentication screen (FIG. 6) to the operation unit 307, receives user information input by the user, and provides the user information to an authentication unit 503. The UI control unit 502 performs control to prevent the user from using the functions of the image forming apparatus 104 through the operation unit 307 until the authentication unit 503 succeeds in authentication. If the authentication is successful, the UI control unit 502 receives job setting information input through the operation unit 307 by the user and provides the job setting information to a job setting management unit 506. The UI control unit 502 also receives a response from the job setting management unit 506 or a job control unit 507 and outputs a screen based on the response to the operation unit 307.

The authentication unit 503 performs authentication using user information received by the UI control unit 502.

Using authentication information included in an authentication request from the data processing apparatus 101, the authentication unit 503 also performs an authentication process on wireless LAN communication with the data processing apparatus 101 and returns the result of the authentication process. Hereinafter, this authentication process will be referred to as “remote authentication”. If the remote authentication is successful, the authentication unit 503 instructs the device connection unit 504 to start the wireless LAN communication.

Using authentication information included in transmission information received from the data processing apparatus 101, the authentication unit 503 also performs an authentication process for determining whether the user has the authority to use the operation unit 307. Then, the authentication unit 503 returns the result of the authentication process. Hereinafter, this authentication process will be referred to as “local authentication”. If the local authentication is successful, the authentication unit 503 instructs the UI control unit 502 to output a screen after login.

The authentication unit 503 stores user authentication information added by the administrator of the image forming apparatus 104 in the HDD 305 and uses the user authentication information when performing various types of authentication. A configuration may be employed in which an external server such as the cloud server 105 manages user authentication information, and the authentication unit 503 performs authentication in cooperation with the external server.

The device connection unit 504 transmits connection information to the data processing apparatus 101 using short-range wireless communication. If local authentication by the authentication unit 503 is successful, the device connection unit 504 starts wireless LAN communication.

The network control unit 505 receives transmission information including job setting information, a job execution command, image data, and authentication information from the data processing apparatus 101 via the network 103. Further, the network control unit 505 transmits job setting information stored in the image forming apparatus 104 to the data processing apparatus 101 via the network 103.

The job setting management unit 506 stores job setting information received by the UI control unit 502 and job setting information received from the data processing apparatus 101 or the cloud server 105 by the network control unit 505 in the RAM 303 or the HDD 305. At this time, the job setting management unit 506 may register these pieces of job setting information as “favorites” as settings frequently used by the user. The job setting management unit 506 may also register predetermined job setting information as “preset” when a program is installed. The job setting management unit 506 may also manage job setting information regarding a job run by the image forming apparatus 104 as “history”.

According to received information regarding jobs, the job control unit 507 controls processing units such as a scan processing unit 511, a copy processing unit 512, a print processing unit 513, and a fax processing unit 514 to run the various jobs. At this time, the job control unit 507 runs the various jobs using job setting information set through the operation unit 307 by the user or job setting information registered as “favorites” or “preset” by the job setting management unit 506. Further, the job control unit 507 runs the various jobs according to job setting information and job execution commands included in transmission information received from the data processing apparatus 101 via the network 103. The job control unit 507 also transmits the execution status of each job and the operation states of devices of the scanner 313 and the printer 314 to the data processing apparatus 101 via the network 103.

### <Examples of Display of Various Screens>

Next, the details of the functions of the data processing apparatus 101 and the image forming apparatus 104 will be described using various screens displayed on the display 214 of the data processing apparatus 101 and the operation unit 307 of the image forming apparatus 104 with reference to FIGS. 6 to 10.

The image forming apparatus 104 outputs an authentication screen for authenticating the user logging into the image forming apparatus 104 to the operation unit 307 under control of the UI control unit 502.

FIG. 6 illustrates an example of display of an authentication screen 601 of the image forming apparatus 104 according to the present exemplary embodiment.

In the authentication screen 601, a user name entry field 602 to which the user name of the user logging in is input, and a password entry field 603 to which a password is input are provided. The user inputs user information to the user name entry field 602 and the password entry field 603. Then, when a login button 604 is pressed, the authentication unit 503 of the image forming apparatus 104 performs authentication using the user information input to the fields 602 and 603.

When the image forming apparatus 104 runs a job of transmitting scan image data to a set destination, the image forming apparatus 104 outputs a transmission screen to the operation unit 307 under control of the UI control unit 502.

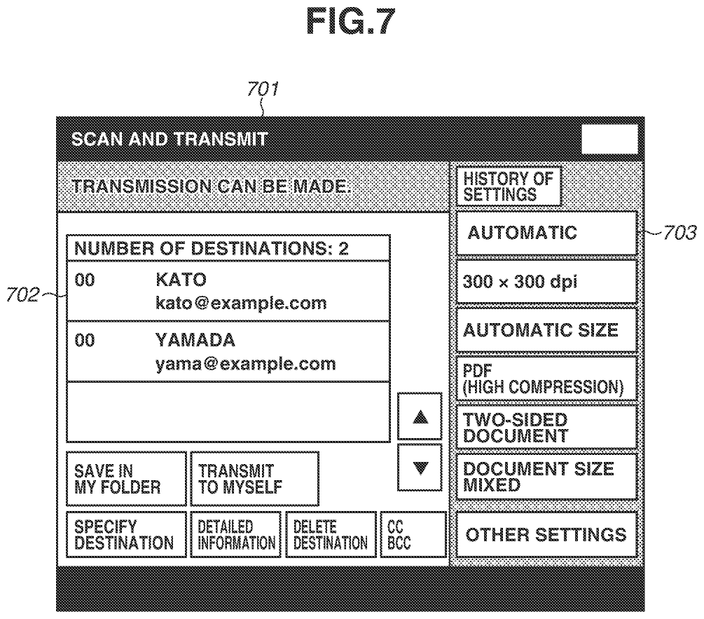

FIG. 7 illustrates an example of display of a transmission screen 701 of the image forming apparatus 104 according to the present exemplary embodiment.

The transmission screen 701 is a screen for setting transmission. In the transmission screen 701, a transmission destination can be selected, and scan settings can be made. In the transmission screen 701, a transmission destination list 702 that displays addresses as transmission destinations, and scan setting buttons 703 that display the current settings of items of scan settings are provided. When the user presses one of the items of the scan setting buttons 703, a scan setting change screen (not illustrated) corresponding to the pressed item is displayed. The job setting management unit 506 of the image forming apparatus 104 changes the scan setting according to operation on the scan setting change screen.

The data processing apparatus 101 outputs a function list screen that displays a list of functions that can be used by the image forming apparatus 104 to the display 214 under control of the UI control unit 402.

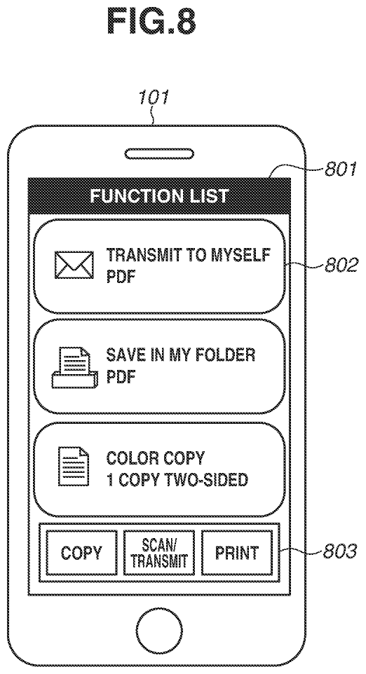

FIG. 8 illustrates an example of display of a “function list” screen 801 of the data processing apparatus 101 according to the present exemplary embodiment.

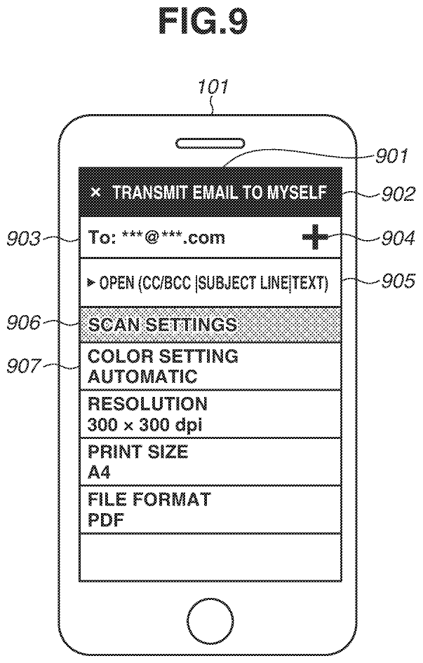

The “function list” screen 801 displays jobs registered as “favorites” and “preset” as buttons, for example. As an example, the jobs include a “transmit to myself” button 802 representing a “transmit to myself” job for transmitting image data scanned by the image forming apparatus 104 to the user (the user of the data processing apparatus 101) by email. When the user presses the “transmit to myself” button 802, a “transmit to myself” setting screen (FIG. 9) is displayed. In the “function list” screen 801, a basic job button area 803 is also provided. In the basic job button area 803, a plurality of buttons for running jobs using basic functions such as “copy” and “print” is arranged. If the user presses each button, a setting screen (not illustrated) for running the job is displayed.

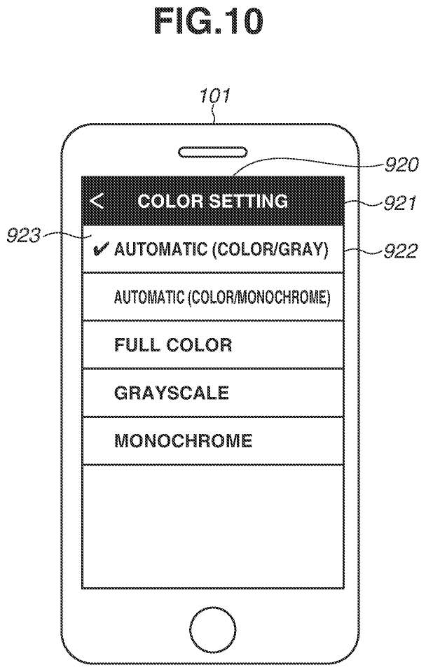

Next, with reference to FIGS. 9 and 10, a method for setting the “transmit to myself” job will be described. If the “transmit to myself” job is selected in the “function list” screen 801 in FIG. 8, the data processing apparatus 101 outputs a “transmit to myself” setting screen to the display 214.

FIG. 9 illustrates an example of display of a “transmit to myself” setting screen 901 of the data processing apparatus 101 according to the present exemplary embodiment. A title 902 displays a title indicating what setting screen this is (“transmit email to myself” in FIG. 9). In the title 902, a button for cancelling the settings and returning to the previous screen is provided. An email address setting area 903 is an area that displays an email address set as a transmission destination. If the email address setting area 903 is pressed, an input can be made to the email address setting area 903 using a software keyboard. If an address book activation button 904 is pressed, an address book is activated. When an email address is selected from the activated address book, the selected email address is displayed in the email address setting area 903. A plurality of email addresses can be set. If an “open” button 905 is pressed, the display switches to a screen (not illustrated) where carbon copy (CC), blind carbon copy (BCC), a subject line, text, and a file name can be set. Then, these items can be input.

A “scan settings” area 906 is an area that displays the current settings of items of scan settings. When the user presses one of the items in the “scan settings” area 906, a scan setting change screen corresponding to the pressed item is displayed. In the “scan settings” area 906, a “color setting” button 907 corresponding to a color setting is displayed as an example of the items of the scan settings. If the user presses the “color setting” button 907, a “color setting” screen (FIG. 10) is displayed.

FIG. 10 illustrates an example of display of a “color setting” screen 920 of the data processing apparatus 101 according to the present exemplary embodiment. The “color setting” screen 920 is a screen displayed on the display 214 with the “color setting” button 907 selected in the “transmit to myself” setting screen 901 in FIG. 9. A title 921 displays a title indicating a “color setting” screen. In the title 921, a button for finalizing the setting and returning to the previous screen is provided. Setting items 922 display items of the color setting. If one of the items is pressed, a check mark 923 in the pressed item is displayed, and the pressed item enters a selected state. The job setting management unit 406 of the data processing apparatus 101 changes the scan setting according to operation on the “color setting” screen 920.

### <Processing Performed by Data Processing Apparatus>

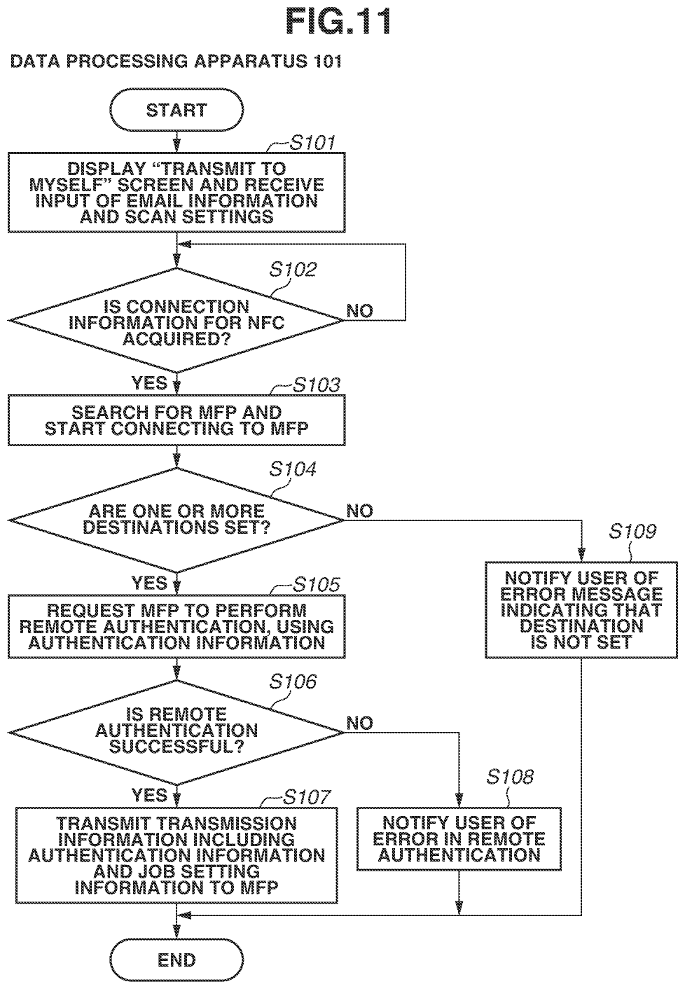

FIG. 11 is a flowchart illustrating an example of processing when the data processing apparatus 101 instructs the image forming apparatus 104 to run the “transmit to myself” job. In FIG. 11 and subsequent figures, “mobile” is an example of the data processing apparatus 101, and “multifunction peripheral (MFP)” is an example of the image forming apparatus 104.

In step S101, if the “transmit to myself” button 802 in the “function list” screen 801 in FIG. 8 is pressed, the CPU 202 outputs the “transmit to myself” setting screen 901. Then, the CPU 202 receives the input of an email address to the email address setting area 903, scan settings in the “scan settings” area 906, and the input of the content of an email to the screen displayed by pressing the “open” button 905 and sets the job.

Next, if the user touches an NFC touch area of the image forming apparatus 104 with the data processing apparatus 101, then in step S102, the CPU 202 waits until connection information for performing wireless LAN communication is acquired from an NFC tag. If the CPU 202 determines that the connection information is acquired (Yes in step S102), the processing proceeds to step S103.

In step S103, the CPU 202 searches for the image forming apparatus 104 using the connection information acquired in step S102 and connects to the image forming apparatus 104.

Next, in step S104, the CPU 202 determines whether one or more email addresses are set in the email address setting area 903. If the CPU 202 determines that one or more email addresses are set (Yes in step S104), the processing proceeds to step S105. If the CPU 202 determines that no email address is set (No in step S104), the processing proceeds to step S109.

In step S105, the CPU 202 reads user authentication information from the storage device 209 and requests the image forming apparatus 104 to perform remote authentication using the read authentication information.

Next, in step S106, the CPU 202 receives a response to the request in step S105 from the image forming apparatus 104, and based on the response, determines whether the remote authentication is successful or fails. If the CPU 202 determines that the remote authentication is successful (Yes in step S106), the CPU 202 establishes wireless LAN communication, and the processing proceeds to step S107. If the CPU 202 determines that the remote authentication fails (No in step S106), the processing proceeds to step S108.

In step S107, the CPU 202 sets the contents (the list of email addresses, the scan settings, and the content of the email) set in the “transmit to myself” setting screen 901 as job setting information and generates transmission information including the job setting information and the authentication information used in step S105.

Then, the CPU 202 transmits the generated transmission information to the image forming apparatus 104 through the wireless LAN communication, and the processing ends.

In step S108, the CPU 202 notifies the user of an error in the remote authentication. For example, the CPU 202 outputs to the display 214 an error message indicating that “wireless LAN communication cannot be performed”, and the processing ends.

In step S109, the CPU 202 outputs to the display 214 an error message indicating that “destination is not set”, and the processing ends.

As described above, the data processing apparatus 101 requests remote authentication using user authentication information regarding the user operating the data processing apparatus 101. If the start of wireless LAN communication is permitted, the data processing apparatus 101 transmits the authentication information together with job setting information to the image forming apparatus 104. Consequently, when the user operating the data processing apparatus 101 instructs the image forming apparatus 104 to run a job, the user can provide authentication information for an authentication process to the image forming apparatus 104 without performing the operation of input to the authentication screen 601 of the image forming apparatus 104. Thus, this configuration can improve the operability for the user.

### <Processing Performed by Image Forming Apparatus>

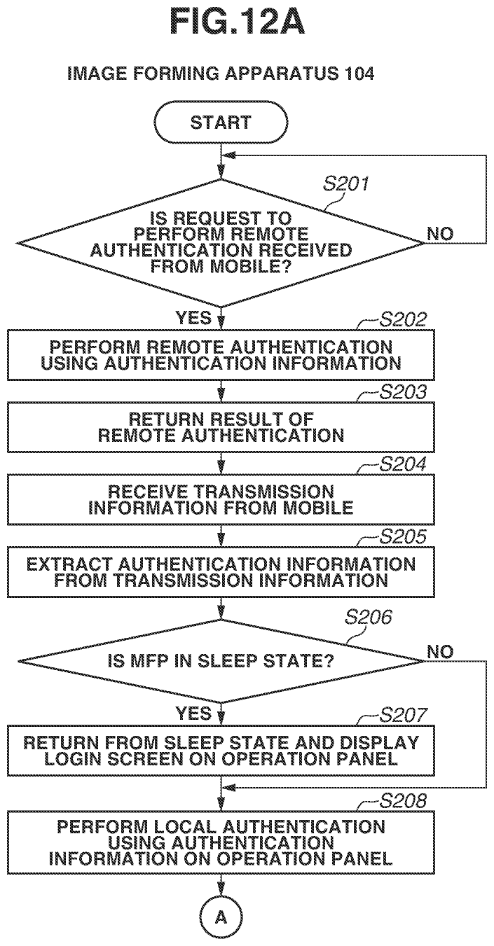

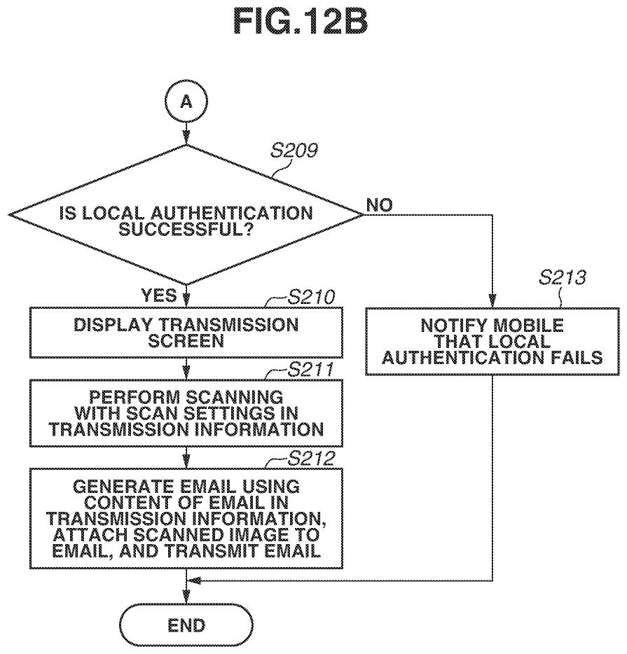

FIG. 12A is a flowchart illustrating an example of processing of the image forming apparatus 104 when a request to perform remote authentication is received from the data processing apparatus 101.

First, in step S201, the CPU 302 waits until a request to perform remote authentication is received from the data processing apparatus 101. If the CPU 302 determines that a request to perform remote authentication is received (Yes in step S201), the processing proceeds to step S202.

In step S202, the CPU 302 performs remote authentication using authentication information included in the request in step S201.

Next, in step S203, the CPU 302 returns information indicating the success or failure of the remote authentication performed in step S202 as a response to the data processing apparatus 101. If the remote authentication is successful, the CPU 302 establishes wireless LAN communication with the data processing apparatus 101. If the remote authentication fails, the processing ends.

Next, in step S204, the CPU 302 receives transmission information from the data processing apparatus 101.

Next, in step S205, the CPU 302 extracts the authentication information from the transmission information received in step S204.

Next, in step S206, the CPU 302 determines whether the operation panel as the operation unit 307 of the image forming apparatus 104 is in a sleep state. If the CPU 302 determines that the operation panel is in the sleep state (Yes in step S206), the processing proceeds to step S207. If the CPU 302 determines that the operation panel is not in the sleep state (No in step S206), step S207 is skipped, and the processing proceeds to step S208.

In step S207, the CPU 302 returns from the sleep state and outputs the authentication screen 601 to the operation unit 307. Depending on the implementation state of the apparatus, the CPU 302 may return from the sleep state, and the processing may proceed to step S208.

In step S208, the CPU 302 performs local authentication using the authentication information extracted in step S205. The local authentication in this case is performed by processing similar to that of authentication performed using user information input to the authentication screen 601.

Next, the processing after A in the flowchart in FIG. 12A will be described.

FIG. 12B is a flowchart illustrating an example of the processing after A illustrated in FIG. 12A.

In step S209, based on the result of the local authentication performed in step S208, the CPU 302 determines whether the local authentication is successful or fails. If the CPU 302 determines that the local authentication is successful (Yes in step S209), the processing proceeds to step S210. If the CPU 302 determines that the local authentication fails (No in step S209), the processing proceeds to step S213. If the processing proceeds to step S210, the user of the data processing apparatus 101 is in the state where the user has logged into the image forming apparatus 104. That is, the user of the data processing apparatus 101 is permitted to use the functions of the image forming apparatus 104 through the operation panel.

In step S210, the CPU 302 extracts job setting information from the transmission information received in step S204 and outputs a setting screen for a job in which the extracted job setting information is reflected, as a screen after login to the operation unit 307. Since the “transmit to myself” job is taken as an example, the CPU 302 outputs the transmission screen 701 as a setting screen for a job of transmitting scan image data to a set destination.

Next, in step S211, based on the job setting information extracted in step S210, the CPU 302 runs the job. Since the “transmit to myself” job is taken as an example, the CPU 302 performs scanning with the scan settings extracted as the job setting information in step S210. If the job setting information is changed by operation being performed on the transmission screen 701 displayed in step S210, the scanning is performed with the changed scan settings.

Next, in step S212, the CPU 302 extracts the content of an email from the job setting information extracted in step S210 and generates a transmission email using the extracted content of the email. Then, the CPU 302 attaches scan image data obtained in step S211 to the transmission email and transmits the email, and the processing ends.

As illustrated in steps S211 and S212, if the local authentication is successful, then based on the job setting information extracted in step S210, the CPU 302 runs the job that the data processing apparatus 101 instructs the image forming apparatus 104 to run.

Referring back to step S209, if the local authentication fails, then in step S213, the CPU 302 does not run the job that the data processing apparatus 101 instructs the image forming apparatus 104 to run, and the CPU 302 notifies the data processing apparatus 101 of an error in the local authentication. Then, the processing ends.

As described above, after wireless communication with the data processing apparatus 101 is authenticated, the image forming apparatus 104 starts the wireless communication, receives transmission information including job setting information and user authentication information regarding the user of the data processing apparatus 101 from the data processing apparatus 101, and performs an authentication process using the user authentication information.

Consequently, when the user runs a job using the data processing apparatus 101, the user can log into the image forming apparatus 104 without performing the operation of input to the authentication screen 601 of the image forming apparatus 104, and can use the functions of the image forming apparatus 104. For example, the user can make detailed settings of the job by operating the operation panel. Thus, this configuration can improve the operability for the user.

In the present exemplary embodiment, the description has been given of processing when the data processing apparatus 101 gives an instruction to run the “transmit to myself” job. Alternatively, also when the data processing apparatus 101 gives an instruction to run a job using the copy function (a copy job), the present exemplary embodiment is applicable by appropriately changing the processing in each flowchart. The same applies to a job using the print function (a print job) and a job using the fax transmission function (a fax job). The print job also includes a job of giving an instruction to print print image data reserved in the image forming apparatus 104.

According to the present exemplary embodiment, using user authentication information set in the data processing apparatus 101, wireless communication can be permitted with the data processing apparatus 101 based on remote authentication, allowing the user of the data processing apparatus 101 to use the operation panel based on local authentication. This can save the user the trouble of performing the operation of inputting the authentication information on the operation panel of the image forming apparatus 104, improving the operability.

A second exemplary embodiment will be described. In the second exemplary embodiment, a description will be given of processing taking into account a case where someone is already logged into the image forming apparatus 104 when the image forming apparatus 104 performs local authentication. The second exemplary embodiment is different from the first exemplary embodiment in the processing after A illustrated in FIG. 12A.

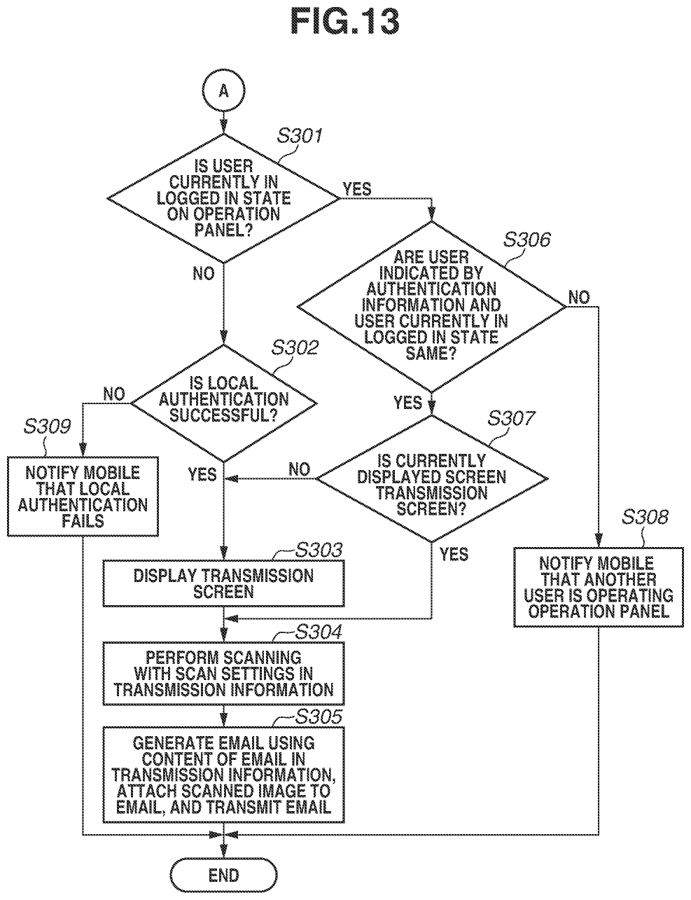

FIG. 13 is a flowchart illustrating the processing A illustrated in FIG. 12A.

In step S301, the CPU 302 determines whether a user is currently logged into the image forming apparatus 104. If the CPU 302 determines that a user is currently logged in (Yes in step S301), the processing proceeds to step S306. If the CPU 302 determines that a user is not currently logged in (No in step S301), the processing proceeds to step S302.

The processes of steps S302 to S305 and S309 are similar to the processes of steps S209 to S213 in FIG. 12B, and the description will be omitted.

In step S306, the CPU 302 checks a user indicated by the authentication information extracted in step S205 against the user currently in a logged-in state and determines whether these users are the same. If the CPU 302 determines that these users are the same (Yes in step S306), the processing proceeds to step S307. If the CPU 302 determines that these users are different from each other (No in step S306), the processing proceeds to step S308.

In step S307, the CPU 302 determines whether a screen currently displayed on the operation unit 307 is the transmission screen 701. If the CPU 302 determines that the transmission screen 701 is currently displayed (Yes in step S307), the screen will not be switched, and the processing proceeds to step S304. If the CPU 302 determines that a screen different from the transmission screen 701 is currently displayed (No in step S307), the screen will be switched, and the processing proceeds to step S303.

In step S308, the CPU 302 notifies the data processing apparatus 101 of an error message indicating that another user is operating the operation panel. Then, the processing ends.

According to the present exemplary embodiment, when the image forming apparatus 104 performs local authentication with a user a currently logged into the image forming apparatus 104, the configuration allows appropriate processing depending on whether the user in a currently logged-in state is the user of the data processing apparatus 101 or another user. Consequently, the user of the data processing apparatus 101 can instruct the image forming apparatus 104 to run a job without being conscious about whether the image forming apparatus 104 is in a logged-in state. Further, if another user is currently logged in, the data processing apparatus 101 is notified that another user is currently logged in, making it possible to prompt the user of the data processing apparatus 101 to take appropriate measures.

In each of the above exemplary embodiments, a description has been given of a configuration in which, if the data processing apparatus 101 instructs the image forming apparatus 104 to run a job, local authentication is always performed. However, there is also a case where it is less necessary to perform local authentication depending on the type of the job. In the following variations, a description will be given of a configuration in which the image forming apparatus 104 switches whether or not to perform local authentication depending on the type of a job that the data processing apparatus 101 instructs the image forming apparatus 104 to run.

First, as a first variation, the image forming apparatus 104 may switch whether or not to perform local authentication based on transmission information received from the data processing apparatus 101. Specifically, in step 5205 in FIG. 12A, the CPU 302 extracts job setting information from the transmission information received in step 5204. Then, the CPU 302 determines whether a job corresponding to the extracted job setting information is a job with local authentication to be made (a first job) or a job without local authentication to be made (a second job). Examples of the job with local authentication to be made include a job of transmitting scanned image to a set destination, a copy job, and a fax job. Examples of the job without local authentication to be made include a print job. In the case of the job with local authentication to be made, the processes of step 5206 and subsequent steps are performed. On the other hand, in the case of the job without local authentication to be made, the processes of step 5206 and subsequent steps are skipped. Then, the CPU 302 runs the job based on the job setting information extracted from the transmission information.

As a second variation, the image forming apparatus 104 may switch whether or not to include authentication information in transmission information to be transmitted to the image forming apparatus 104 depending on the type of a job that the data processing apparatus 101 instructs the image forming apparatus 104 to run. Specifically, in step S107 in FIG. 11, the CPU 202 determines whether the job that the data processing apparatus 101 instructs the image forming apparatus 104 to run is a job with local authentication to be made (a first job) or a job without local authentication to be made (a second job). Then, in the case of the job with local authentication to be made, the CPU 202 includes the job setting information and the authentication information used in step S105 in the transmission information. On the other hand, in the case of the job without local authentication to be made, the CPU 202 includes the job setting information in the transmission information and does not include the authentication information used in step S105 in the transmission information. In this case, in step S205 in FIG. 12A, if the authentication information is not included in the transmission information received in step S204, the CPU 302 skips the processes of step 5206 and subsequent steps and runs the job based on the job setting information extracted from the transmission information received in step 5204.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-163471, filed Oct. 4, 2021, which is hereby incorporated by reference herein in its entirety.

What is claimed is:

1. An information processing system including an image forming apparatus and an information processing apparatus that connects to the image forming apparatus through wireless communication,
the information processing apparatus comprising:
a request unit configured to request the image forming apparatus to authenticate wireless communication with the information processing apparatus, using set user authentication information; and
a transmission unit configured to, in a case where the wireless communication with the image forming apparatus is started as a result of the authentication of the wireless communication, transmit transmission information including the user authentication information used in the request and job setting information regarding a job that the information processing apparatus instructs the image forming apparatus to run to the image forming apparatus,
the image forming apparatus comprising:
a first authentication unit configured to, in a case where the image forming apparatus receives the request from the information processing apparatus, authenticate the wireless communication with the information processing apparatus based on the user authentication information used in the request; and
a connection unit configured to, in a case where the authentication of the wireless communication is successful, start the wireless communication with the information processing apparatus.

2. The information processing system according to claim 1, wherein the image forming apparatus further comprises:
a reception unit configured to receive the transmission information from the information processing apparatus;
a second authentication unit configured to, based on the user authentication information included in the transmission information, perform authentication regarding whether a user has authority to use an operation unit of the image forming apparatus; and
a processing unit configured to perform processing based on a result of the authentication by the second authentication unit.

3. The information processing system according to claim 2, wherein in a case where the authentication by the second authentication unit is successful, the processing unit runs the job based on the job setting information included in the transmission information.

4. The information processing system according to claim 2, wherein in a case where the authentication by the second authentication unit is successful, the processing unit outputs a setting screen for the job to a display unit of the image forming apparatus based on the job setting information included in the transmission information.

5. The information processing system according to claim 2, wherein in a case where the authentication by the second authentication unit fails, the processing unit notifies the information processing apparatus of an error in the authentication.

6. The information processing system according to claim 2, wherein in a case where a user is not currently logged into the image forming apparatus, the second authentication unit performs the authentication, and in a case where a user is currently logged into the image forming apparatus, the second authentication unit does not perform the authentication.

7. The information processing system according to claim 6, wherein in a case where a user is currently logged into the image forming apparatus, and the user currently logged in and a user corresponding to the user authentication information included in the transmission information are the same as each other, the second authentication unit outputs a setting screen for the job to a display unit of the image forming apparatus based on the job setting information included in the transmission information.

8. The information processing system according to claim 6, wherein in a case where a user is currently logged into the image forming apparatus, and the user currently logged in and a user corresponding to the user authentication information included in the transmission information are different from each other, the second authentication unit notifies the information processing apparatus that another user is currently logged in.

9. The information processing system according to claim 2,
wherein in a case where the job that the information processing apparatus instructs the image forming apparatus to run is a first job, the second authentication unit performs the authentication, and in a case where the job that the information processing apparatus instructs the image forming apparatus to run is a second job different from the first job, the second authentication unit does not perform the authentication, and
wherein in a case where the authentication by the second authentication unit is not performed, the processing unit runs the job based on the job setting information included in the transmission information.

10. The information processing system according to claim 9, wherein the first job includes at least one of a job of transmitting an image scanned by the image forming apparatus to a set destination, a copy job, or a fax job.

11. The information processing system according to claim 9, wherein the second job includes a print job.

12. The information processing system according to claim 1, wherein the job that the information processing apparatus instructs the image forming apparatus to run is a job of transmitting an image scanned by the image forming apparatus to a set destination, a copy job, a print job, or a fax job.

13. The information processing system according to claim 1, wherein in a case where the job that the information processing apparatus instructs the image forming apparatus to run is a first job, the transmission unit includes the user authentication information in the transmission information, and in a case where the job that the information processing apparatus instructs the image forming apparatus to run is a second job different from the first job, the transmission unit does not include the user authentication information in the transmission information.

14. The information processing system according to claim 1,
wherein the request unit acquires connection information from the image forming apparatus through short-range wireless communication, and
wherein the request unit searches for the image forming apparatus using the acquired connection information and requests the image forming apparatus found by the search to authenticate the wireless communication.

15. The information processing system according to claim 1, wherein the information processing apparatus further comprises a management unit configured to manage authentication information input by a user.

16. The information processing system according to claim 1, wherein the information processing apparatus further comprises a setting unit configured to set job setting information regarding a job that the information processing apparatus instructs the image forming apparatus to run.

17. The information processing system according to claim 1, wherein the user authentication information is a user name and a password.

18. The information processing system according to claim 1, wherein the information processing apparatus is a mobile terminal.

19. A control method for controlling an information processing system including an image forming apparatus and an information processing apparatus that connects to the image forming apparatus through wireless communication, the control method comprising:
causing the information processing apparatus to request the image forming apparatus to authenticate wireless communication with the information processing apparatus, using set user authentication information;
in a case where the image forming apparatus receives the request from the information processing apparatus, causing the image forming apparatus to authenticate the wireless communication with the information processing apparatus based on the user authentication information used in the request;
in a case where the authentication of the wireless communication is successful, causing the image forming apparatus to start the wireless communication with the information processing apparatus; and
in a case where the wireless communication with the image forming apparatus is started, causing the information processing apparatus to transmit transmission information including the user authentication information used in the request and job setting information regarding a job that the information processing apparatus instructs the image forming apparatus to run to the image forming apparatus.
